(19) United States
(12) Patent Application Publication
(10) Pub. No.: US 2022/0410931 A1
(43) Pub. Date: Dec. 29, 2022

(54) SITUATIONAL AWARENESS IN A VEHICLE

(71) Applicant: Ford Global Technologies, LLC, Dearborn, MI (US)

(72) Inventors: Gabrielle Jost, Niederzier (DE); Ahmed Benmimoun, Aachen (DE); Thomas Nowak, Aldenhoven (DE); Chenhao Ma, Canton, MI (US); Hamid M. Golgiri, Livonia, MI (US); Tony Tae-Jin Pak, Garden City, MI (US); Youssef Elminyawi, Washington, DC (US); Anoop Mishra, Aachen (DE)

(73) Assignee: Ford Global Technologies, LLC, Dearborn, MI (US)

(21) Appl. No.: 17/844,942

(22) Filed: Jun. 21, 2022

(30) Foreign Application Priority Data
Jun. 29, 2021 (EP) 21182320.8

(51) Int. Cl. B60W 60/00; B60W 40/04; B60W 30/09; B60W 30/095; G06V 20/58; G06V 20/40; G06V 10/60

(52) U.S. Cl. CPC B60W 60/0011; B60W 60/0015; B60W 40/04; B60W 30/09; B60W 30/0956; G06V 20/584; G06V 20/46; G06V 10/60; B60W 2420/42; B60W 2554/4045

(57) ABSTRACT

Enhancing situational awareness of an advanced driver assistance system in a host vehicle can be provided by acquiring, with an image sensor, an image data stream comprising a plurality of image frames. Analyzing A vision processor can analyze the image data stream to detect objects, shadows and/or lighting in the image frames. Recognizing A situation recognition engine can recognize at least one most probable traffic situation out of a set of predetermined traffic situations taking into account the detected objects, shadows and/or lighting. A processor can then control the host vehicle taking into account the at least one most probable traffic situation.

### CROSS-REFERENCE TO RELATED APPLICATIONS

This application claims priority to European Patent Application No. 21182320.8, filed Jun. 29, 2021, which is hereby incorporated by reference in its entirety.

### BACKGROUND

Advanced driver assistance systems in vehicles, including Valet Parking Assistance (VaPA), may provide fully automated steering and manoeuvring. Such systems use automated vehicle controls, along with camera, Lidar, radar, GPS (Global Positioning System), proximity and/or ultrasonic sensors to register, identify and interpret their surroundings.

A VaPA system identifies parking slots, navigates and parks the vehicle without user oversight or input. The system may also be able to autonomously drive the parked vehicle from a parking slot to a specified pickup location upon request by the user.

Other advanced driver assistance systems may include assisted driving in urban traffic, autonomous emergency braking, rear and front cross-traffic alerts and a reverse brake assist.

Highly automated driver assistance systems, that are intended to function without any human supervision, increase the need for the sensing system to sense and interpret the environment it is moving in.

The classical sensing and perception that is based on detecting and classifying objects which are in field of view of a camera may fall short when compared to the performance of an average driver who besides assessing what is in his or her field of view, has a certain anticipation of upcoming events based on mere indications. As the human supervision is eliminated from the equation when addressing highly automated systems such as Automated Valet Parking, there is a need for these systems to build similar situational awareness, especially when targeting a performance that is at least on eye level with an average human driver.

### SUMMARY

According to an aspect, the present disclosure relates to a method for enhanced situational awareness of an advanced driver assistance system (ADAS) in a host vehicle. According to another aspect, the disclosure relates to an advanced driver assistance system and to an autonomous driving system for a vehicle.

Accordingly, disclosed herein is a method of enhanced situational awareness of an advanced driver assistance system in a host vehicle. The disclosure further includes a corresponding advanced driver assistance system (ADAS) and autonomous driving system, a corresponding computer program, and a corresponding computer-readable data carrier.

According to a first aspect, the method for enhancing situational awareness of an advanced driver assistance system in a host vehicle comprises the following steps:

S1: acquiring, with an image sensor, an image data stream comprising a plurality of image frames;

S2: analyzing, with a vision processor, the image data stream to detect objects, shadows and/or lighting in the image frames;

S3: recognizing, with a situation recognition engine, at least one most probable traffic situation out of a set of predetermined traffic situations taking into account the detected objects, shadows and/or lighting; and

S4: controlling, with a processor, the host vehicle taking into account the at least one most probable traffic situation.

In the context of this disclosure, a vision processor may be understood to be a computational unit, i.e., a computing device including a processor and a memory, optimized for processing image data. An embedded vision processor may be based on heterogeneous processing units comprising, for example, a scalar unit and an additional vector DSP (digital signal processing) unit for handling parallel computations for pixel processing of each incoming image.

In the past, for each type of object to be detected, traditional computer vision algorithms were hand-coded. Examples of algorithms used for detection include “Viola-Jones” or “Histogram of Oriented Gradients” (HOG). The HOG algorithm looks at the edge directions within an image to try to describe objects. Generally, these approaches still work today.

However, due to the breakthrough of deep neural networks, object detection no longer has to be a hand-coding exercise. Deep neural networks allow features to be learned automatically from training examples. In this regard, a neural network is considered to be “deep” if it has an input and output layer and at least one hidden middle layer. Each node is calculated from the weighted inputs from multiple nodes in the previous layer. Convolutional neural networks (CNNs) can be used for efficiently implementing deep neural networks for vision. Accordingly, a vision processor may also comprise an embedded CNN engine. Modern embedded CNN engines may be powerful enough for processing whole incoming image frames of an image stream. The benefit of processing the entire image frame is that CNN can be trained to simultaneously detect multiple objects, such as traffic participants (automobiles, pedestrians, bicycles, etc.), obstacles, borders of the driving surface, road markings and traffic signs.

Taking into account the information provided by the vision processor, as well as additional information available to the advanced driver assistance system, the situation recognition engine is adapted to recognize one out of a set of predetermined traffic situations as being the best matching to the current situation. The situation recognition engine may be based on deterministic approaches, probabilistic approaches, fuzzy approaches, conceptual graphs, or again on deep learning/neural networks. In the simplest form, the situation recognition engine can—for example—be based on a hardcoded decision tree. In deterministic models, the recognized situation is precisely determined through known relationships among states and events. Probabilistic models predict the situation by calculating the probability of all possible situations based on temporal and spatial parameters. A fuzzy model includes a finite set of fuzzy relations that form an algorithm for recognizing the situation from some finite number of past inputs and outputs. Conceptual graphs belong to the logic-based approaches, but they also benefit from the graph theory and graph algorithms.

Based on the most probable situation, recognized by the situation recognition engine, the advanced driver assistance system may adapt the current or planned driving manoeuvres.

Advantageously, experience-based indications can be taken into consideration to anticipate changes in the detected scenario before they become manifest.

Instead of only relying on the detection of objects in the field-of-view, the present approach considers the additional information contained in an optical image of the presented scene to allow for a better anticipation of how the scene might change in the near future. This includes anticipating the presence of other traffic participants that are not visible yet but also includes anticipating a change of a traffic participant from a static traffic participant to a dynamic traffic participant in the near future.

In some embodiments, analyzing the image data stream comprises detecting shadows in the image frames.

In particular, analyzing the image data stream may comprise detecting dynamic shadows. Detecting dynamic shadows allows for easy recognition of moving traffic participants. Dynamic shadows may be detected by comparing at least a first and a second image frame of the image data stream.

Movements and/or changes in size of the dynamic shadows can be detected with reference to the surfaces the respective shadows are cast on. Directly comparing a shadow with the shape and/or other features of the underlying surface simplifies detection of dynamic shadows as it compensates changes in perspective due to movement of the host vehicle.

In some embodiments, the set of predetermined traffic situations include traffic situations comprising an out-of-sight traffic participant casting a shadow into the field-of-view of the image sensor. Traffic situations in this context may refer to situation templates, respective objects or similar data structures, as well as the “real life” traffic situation these data structures represent.

This enables the advanced driver assistance system to anticipate an out-of-sight traffic participant.

If the detected shadow is moving, a trajectory of the movement can be evaluated for anticipating movement of the corresponding out-of-sight traffic participant.

In some embodiments, the set of predetermined traffic situations include traffic situations comprising a row of parking slots, wherein a plurality, but not all, of the parking slots are occupied by respective cars. According to the traffic situation, the cars in the occupied parking slots respectively cast a shadow into the field-of-view of the image sensor of the host vehicle. This way, an unoccupied parking slot in the row of parking slots can be identified or at least anticipated by lack of a corresponding shadow, even if the unoccupied parking slot itself is still out-of-sight or covered behind parked cars.

According to another advantageous aspect, the step of recognizing at least one most probable traffic situation out of a set of predetermined traffic situations can comprise reducing a probability value relating to traffic situations comprising an object as it has been detected by the vision processor, if the detected object lacks a corresponding shadow although such shadow would be expected due to existing lighting conditions.

In some embodiments, the probability value is only reduced if the detected object lacks a corresponding shadow although all other objects detected by the vision processor in vicinity of the detected object cast a respective shadow.

In other words, shadows or rather the absence of shadows when they would be expected could be used to identify if an object that was identified by the optical sensing system is a ghost object (false positive). It should be noted, though, that this technique is only applicable in case the illumination conditions support that 3D objects cast shadows.

According to another advantageous aspect, analyzing the image data stream can comprise detecting artificial lighting in the image frames. Like shadows, lighting can be used as an indicator for anticipating the presence and/or a movement of a traffic participant that is out-of-view, even before it becomes visible to the image sensor.

In some embodiments, the artificial lighting being detected can be dynamic, e.g. moving and/or changing size in relation to the illuminated surfaces and/or objects. Detecting dynamic lighting simplifies distinguishing between most likely relevant and most likely irrelevant lighting. Static lighting is more likely to be irrelevant.

In some embodiments, the set of predetermined traffic situations includes traffic situations comprising a traffic participant with active vehicle lighting. The active vehicle lighting can comprise at least one out of brake lights, reversing lights, direction indicator lights, hazard warning lights, low beams and high beams. The active vehicle lighting emits the artificial lighting to be detected by the vision processor in the image frames. Vehicle lighting of other traffic participants may provide additional information to be used for understanding the environment of the host vehicle.

In particular, the set of predetermined traffic situations can include traffic situations for anticipating an out-of-sight traffic participant with active vehicle lighting being detectable in the field-of-view of the image sensor. For example, the active vehicle lighting can illuminate objects, surfaces and/or airborne particles in the field-of-view of the image sensor, which makes the vehicle lighting detectable in the image data stream.

In some embodiments, the set of predetermined traffic situations includes traffic situations for anticipating traffic participants suddenly moving into a path of the host vehicle. The traffic situations may respectively comprise a traffic participant with active vehicle lighting in the field-of-view of the image sensor. The active vehicle lighting being of a defined type, which can be identified.

According to another aspect, there is provided an advanced driver assistance system (ADAS) for a vehicle, comprising an image sensor, a vision processor, a situation recognition engine and a processor. The advanced driver assistance system is configured to carry out the method described in the above.

According to still another aspect, an autonomous driving system for a vehicle, comprising vehicle sensor apparatus, control and servo units configured to autonomously drive the vehicle, at least partially based on vehicle sensor data from the vehicle sensor apparatus, and the advanced driver assistance system described in the above.

According to yet another aspect, there is provided a computer program comprising instructions which, when the program is executed by a controller, cause the controller to carry out the method described in the above.

According to still another aspect, a computer-readable data carrier having stored thereon the computer program described in the above is provided. Said data carrier may also store a database of known traffic scenarios.

### BRIEF SUMMARY OF THE DRAWINGS

The disclosure will now be described in more detail with reference to the appended figures. In the figures:

FIG. 1 shows a simplified diagram of an exemplary method.

FIG. 2 shows a schematic example of an application of the exemplary method.

FIG. 3 shows a second schematic example of an application of the exemplary method.

FIG. 4 shows a third schematic example of an application of the exemplary.

FIG. 5 shows a fourth schematic example of an application of the exemplary method.

FIG. 6 shows a fifth example of an application of the exemplary method.

### DESCRIPTION

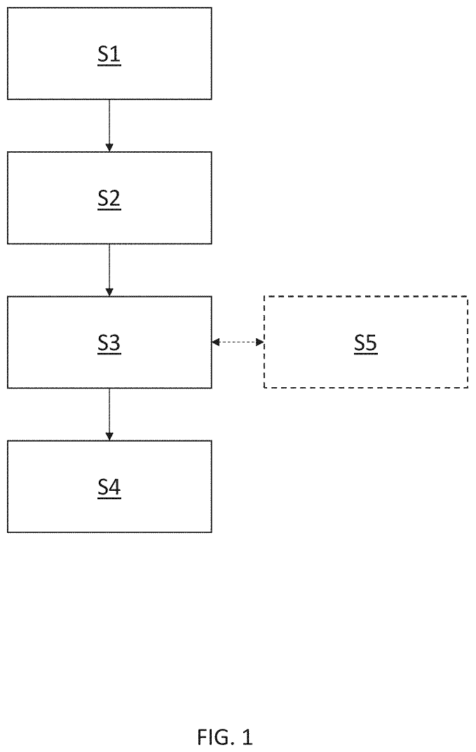

Turning to FIG. 1, which shows a simplified diagram of a method for enhancing situational awareness of an advanced driver assistance system in a host vehicle.

The method comprises the following steps:

S1: Acquiring, with an image sensor, an image data stream comprising a plurality of image frames.

S2: Analyzing, with a vision processor, the image data stream to detect objects 10, shadows 20 and/or lighting 30 in the image frames.

S3: Recognizing, with a situation recognition engine, at least one most probable traffic situation out of a set of predetermined traffic situations taking into account the detected objects 10, shadows 20 and/or lighting 30.

S4: Controlling, with a processor, the host vehicle 1 taking into account the at least one most probable traffic situation.

The method may further comprise:

S5: Reducing a probability value relating to traffic situations comprising an object 17 as it has been detected by the vision processor if the detected object 17 lacks a corresponding shadow although such shadow would be expected due to existing lighting conditions. In one example, the probability value is only reduced if all other objects 10 detected by the vision processor in vicinity of the detected object 17 cast a respective shadow 20.

The method enhances and/or facilitates the situational awareness of a highly automated driver assistance system, such as in automated valet parking, by using optical detections of shadows 20 and/or light beams 30, which are cast by other traffic participants 10.

As shadows 20 and/or light beams 30 usually reach further than their source, they can be used to already anticipate the presence of other traffic participants 11 before they are physically in the field of view of the host vehicle's 1 sensors.

Additionally, a shadow analysis can be used to evaluate the presence or absence of a possible ghost object. A ghost object 17 is a wrongly detected, fake object.

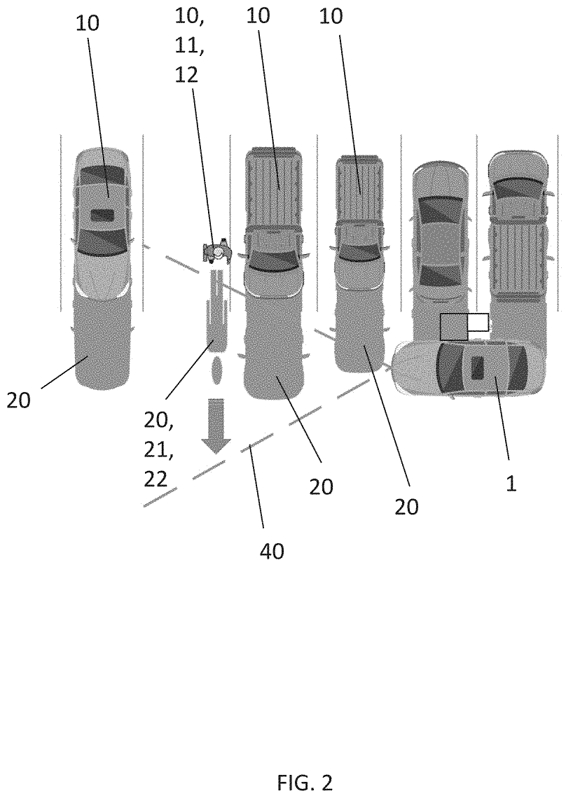

The method is further explained with regard to the respective examples of application as depicted in the following FIGS. 2 to 6.

Advantageously, analyzing the image data stream comprises detecting shadows 20 in the image frame, as they are shown in FIGS. 2 to 4.

Referring now to any of the FIGS. 2 to 4, 3D objects 10 will usually cast a shadow 20 in one direction or another. If contrast within the image data stream is high enough, these shadows can be detected by a camera system.

Depending on the angle of the light source to the object 10,11 that casts the shadow 20, the shadow 20 might be larger than the object 10,11 that casts it.

The shadows 21 of hidden traffic participants 11 can be used to anticipate their presence, although they themselves are not in the field of view 40 of the host vehicle already.

In FIG. 2, from the host vehicle's perspective, the pedestrian is not in the field of view 40 yet and therefore cannot directly be detected. The shadow 21 the pedestrian is casting, however, is already visible to the camera of the host vehicle 1 comprising the image sensor.

If the shadow is correctly identified, it can be used to anticipate that a pedestrian or other traffic participant 10 is about to cross the road in front of the host vehicle 1 in the near future. The host vehicle 1 can use this additional information to adapt its driving behaviour by a) slowing down or stopping if moving, or b) waiting until the other traffic participant has crossed the host vehicle's planned trajectory before launching.

Furthermore, as shadows can be rather unshapely and therefore their origin is sometimes hard to identify, a variant is to consider dynamic shadows 22 only. Again referring to FIG. 2, as the pedestrian 12 is moving, the shape of the shadow 22 in the host vehicle's field-of-view 40 will change accordingly. In this case, there is no need to identify the shadow's 22 origin, as the fact that the shadow 22 is dynamic already indicates that it originates from a moving traffic participant 12 rather than from infrastructure or other static obstacles.

Especially in complex environments such as parking lots with many obstructing objects, this can be helpful to better understand the traffic situation and react in time to other traffic participants 10.

In addition, dynamic shadows 22 are usually simpler to detect if movements and/or changes in size of the dynamic shadows 22 are referenced to the surfaces on which the respective shadows 22 are cast on.

For enabling the advanced driver assistance system according to aspects of the disclosure, the set of predetermined traffic situations used for recognizing the most probable traffic situation include traffic situations comprising out-of-sight traffic participants 11 casting a shadow 21 into the field-of-view 40 of the image sensor. Preferably, the set of predetermined traffic situations also include traffic situations having the shadow 21 being a moving shadow 22.

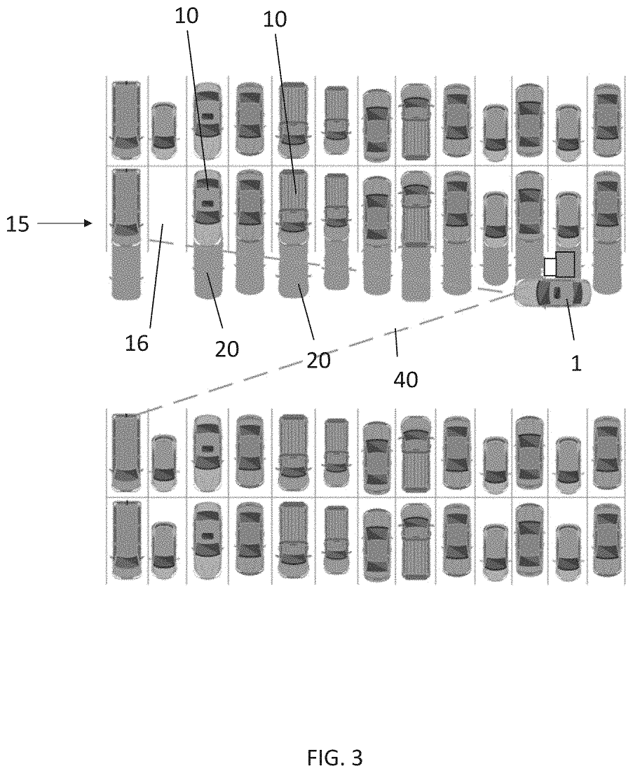

Turning to FIG. 3, the set of predetermined traffic situations also includes traffic situations comprising a row 15 of parking slots, wherein a plurality but not all of the parking slots are occupied by respective cars, the cars in the occupied parking slots respectively casting a shadow 20 into the field-of-view 40 of the image sensor. An unoccupied parking slot 16 can thus be identified by lack of a corresponding shadow even if the unoccupied parking slot 16 itself is still out-of-sight.

In other words, the general shadow-based approach of detecting other traffic participants 10 before they are in the host vehicle's field-of-view as described before with regard to FIG. 2, can also be used to identify empty parking slots 16 when searching in a parking lot. The contrast between a row 15 of vehicles 10 casting a shadow 20 vs. the gap without a shadow in-between could be used to identify an empty slot 16 when driving down an aisle even before reaching the particular slot.

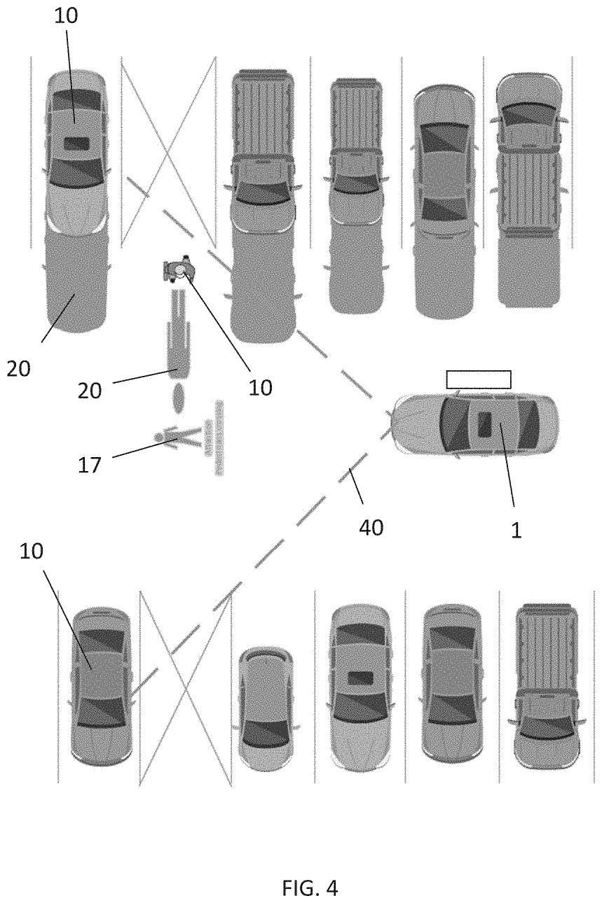

In FIG. 4, a traffic situation comprising a ghost object 17 is shown. As previously stated, ghost objects are non-real objects, which falsely are detected by the respective algorithm.

Shadows, or rather the absence of shadows when they would be expected, can also be used to identify if an object that was detected by the advanced driver assistance system is a false positive, i.e., a ghost object 17. In the depicted traffic situation, the pedestrian that is entering the field-of-view 40 of the host vehicle 1 is casting a shadow 20 similar to all vehicles that are parked along the side. The street painting on the pavement directly in front of the host vehicle 1, however, does not cast any shadow as it is a mere 2D image painted on the road to raise driver's awareness of pedestrians. To increase confidence that the person drawn on the pavement is not a real person laying on the ground, the absence of a shadow could be used. Of course, this method is only applicable in case the illumination conditions support that 3D objects cast shadows.

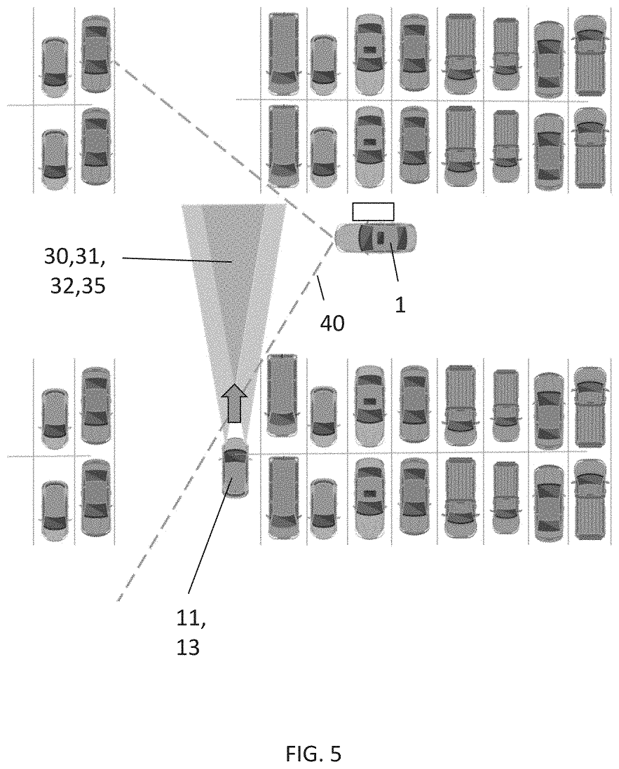

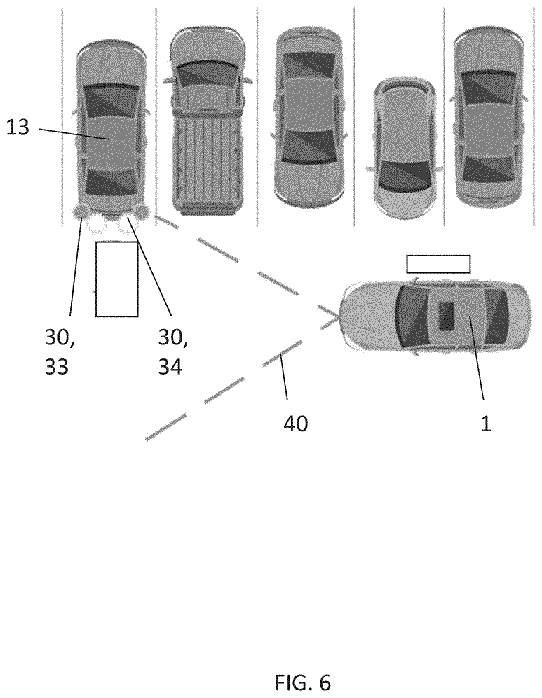

Turning to FIGS. 5 and 6, analyzing the image data stream advantageously comprises detecting artificial lighting 30 in the image frame.

The set of predetermined traffic situations for recognizing the most probable traffic situation includes traffic situations comprising a traffic participant 13 with active vehicle lighting 30. The active vehicle lighting 30, for example, can comprise brake lights 33, reversing lights 34, direction indicator lights, hazard warning lights, low beams 35 and/or high beams, respectively emitting the artificial lighting 30 to be detected in the image frames.

As shown in FIG. 5, the contrast between light and shadow can be used once ambient illumination is low and other traffic participants (e.g., vehicles, motorcycles etc.) are driving with low beams 35 or high beams on.

In this case, the light beam 31 that the other traffic participant 13 is producing reaches far ahead of the traffic participant 13 itself. Especially in cases in which the other traffic participant 13 is not in the field-of-view of the host vehicle 1 yet, the low beams 35 can be detected early.

In the traffic situation depicted, the host vehicle 1 is approaching an intersection. The field of view 40 of the host vehicle 1 is empty but the low beams 35 of the other vehicle 13 are already visible within the field-of-view of the host vehicle 1, thus, indicating the presence of the other traffic participant 13.

A corresponding traffic situation of a predetermined set of traffic situations for anticipating an out-of-sight traffic participant 11 comprises the out-of-sight traffic participant 11 with active vehicle lighting 30. The active vehicle lighting 30 is detectable in the field-of-view 40 of the image sensor.

The active vehicle lighting 30 may illuminate objects (e.g., other cars), surfaces (e.g. the street), and/or airborne particles (e.g. fog, rain or snow) in the field-of-view 40 of the image sensor.

The artificial lighting 30 to be detected can be dynamic lighting 32, which is moving and/or changing size in relation to the surfaces and/or objects being illuminated. A misinterpretation of other non-relevant light sources that are part of the infrastructure can thereby be mitigated. In order to determine if the light beam is static or dynamic the illumination of subsequent captured images can be compared to each other. In case of a dynamic beam, the illuminated area of the image would move gradually along a trajectory in a specific direction.

Turning to FIG. 6, the set of predetermined traffic situations includes traffic situations for anticipating traffic participants, which may suddenly be moving into a path of the host vehicle 1. The respective traffic situations comprise a traffic participant 13 with active vehicle lighting 30 in the field-of-view of the image sensor. According to an aspect, the active vehicle lighting 30 is of a defined type, in this particular case the active vehicle lighting 30 comprises brake lights 33 and reversing lights 34.

In other words, the potential to anticipate the future behaviour of other traffic participants 13 that are already in the field-of-view can be enhanced by analyzing the traffic participants' 13 lighting. If the host vehicle 1 is driving down the aisle of a parking lot, it can sense, if any of the vehicles has turned on its vehicle lighting via camera. A vehicle with turned on vehicle lighting could then be assumed to be about to move, although being static at the moment.

This information may help avoid collisions, as the host vehicle 1 slows down or stops in case the driver of the other vehicle does not see it. Additionally, in crowded parking lots, it could be a strategy to wait until the other vehicle has parked out to use the empty slot.

The description of embodiments of the invention is not intended to limit the scope of protection to these embodiments. The scope of protection is defined in the following claims.

1-14. (canceled)

15. A computing device for a vehicle, including a processor and a memory configured such that the computing device is programmed to:
acquire, with an image sensor, an image data stream comprising a plurality of image frames;
analyze, with a vision processor, the image data stream to detect objects, shadows and/or lighting in the image frames, wherein analyzing the image data stream comprises detecting artificial lighting in the image frames, the artificial lighting being dynamic lighting that includes at least one of moving or changing size in relation to surfaces or objects being illuminated;
recognize, with a situation recognition engine, at least one most probable traffic situation out of a set of predetermined traffic situations taking into account the detected objects, shadows and/or lighting; and
control the vehicle taking into account the at least one most probable traffic situation.

16. The computing device of claim 15, further programmed to analyze the image data stream by detecting shadows in the image frames.

17. The computing device of claim 16, further programmed to analyze the image data stream by detecting dynamic shadows, wherein movements and/or changes in size of the dynamic shadows are detected with reference to the surfaces the respective shadows are cast on.

18. The computing device of claim 16, wherein the set of predetermined traffic situations include traffic situations for anticipating an out-of-sight traffic participant, the traffic situations including the out-of-sight traffic participant casting a shadow into the field-of-view of the image sensor, wherein the shadow is a moving shadow.

19. The computing device of claim 16, wherein the set of predetermined traffic situations include traffic situations comprising a row of parking slots, wherein a plurality, but not all, of the parking slots are occupied by respective cars, the cars in the occupied parking slots respectively casting a shadow into the field-of-view of the image sensor, an unoccupied parking slot being identifiable by lack of a corresponding shadow even if the unoccupied parking slot itself is still out-of-sight.

20. The computing device of claim 15, wherein recognizing at least one most probable traffic situation out of a set of predetermined traffic situations includes reducing a probability value relating to traffic situations comprising an object as it has been detected by the vision processor if the detected object lacks a corresponding shadow although such shadow would be expected due to existing lighting conditions, including when all other objects detected by the vision processor in vicinity of the detected object cast a respective shadow.

21. The computing device of claim 15, wherein the set of predetermined traffic situations includes traffic situations comprising a traffic participant with active vehicle lighting, in particular wherein the active vehicle lighting comprises at least one out of brake lights, reversing lights, direction indicator lights, hazard warning lights, low beams and high beams, emitting the artificial lighting to be detected in the image frames.

22. The computing device of claim 15, wherein the set of predetermined traffic situations includes traffic situations for anticipating an out-of-sight traffic participant, the traffic situations comprising the out-of-sight traffic participant with active vehicle lighting, the active vehicle lighting being detectable in the field-of-view of the image sensor and illuminating one or more of objects, surfaces, or airborne particles in the field-of-view of the image sensor.

23. The computing device of claim 15, wherein the set of predetermined traffic situations includes traffic situations for anticipating traffic participants suddenly moving into a path of the host vehicle, the traffic situations respectively comprising the traffic participant with active vehicle lighting in the field-of-view of the image sensor, the active vehicle lighting being of a defined type.

24. A method, comprising:
acquiring, with an image sensor, an image data stream comprising a plurality of image frames;
analyzing, with a vision processor, the image data stream to detect objects, shadows and/or lighting in the image frames, wherein analyzing the image data stream comprises detecting artificial lighting in the image frames, the artificial lighting being dynamic lighting that includes at least one of moving or changing size in relation to surfaces or objects being illuminated;
recognizing, with a situation recognition engine, at least one most probable traffic situation out of a set of predetermined traffic situations taking into account the detected objects, shadows and/or lighting; and
controlling the vehicle taking into account the at least one most probable traffic situation.

25. The method of claim 24, further comprising analyzing the image data stream by detecting shadows in the image frames.

26. The method of claim 25, further comprising analyzing the image data stream by detecting dynamic shadows, wherein movements and/or changes in size of the dynamic shadows are detected with reference to the surfaces the respective shadows are cast on.

27. The method of claim 25, wherein the set of predetermined traffic situations include traffic situations for anticipating an out-of-sight traffic participant, the traffic situations including the out-of-sight traffic participant casting a shadow into the field-of-view of the image sensor, wherein the shadow is a moving shadow.

28. The method of claim 25, wherein the set of predetermined traffic situations include traffic situations comprising a row of parking slots, wherein a plurality, but not all, of the parking slots are occupied by respective cars, the cars in the occupied parking slots respectively casting a shadow into the field-of-view of the image sensor, an unoccupied parking slot being identifiable by lack of a corresponding shadow even if the unoccupied parking slot itself is still out-of-sight.

29. The method of claim 24, wherein recognizing at least one most probable traffic situation out of a set of predetermined traffic situations includes reducing a probability value relating to traffic situations comprising an object as it has been detected by the vision processor if the detected object lacks a corresponding shadow although such shadow would be expected due to existing lighting conditions, including when all other objects detected by the vision processor in vicinity of the detected object cast a respective shadow.

30. The method of claim 24, wherein the set of predetermined traffic situations includes traffic situations comprising a traffic participant with active vehicle lighting, in particular wherein the active vehicle lighting comprises at least one out of brake lights, reversing lights, direction indicator lights, hazard warning lights, low beams and high beams, emitting the artificial lighting to be detected in the image frames.

31. The method of claim 24, wherein the set of predetermined traffic situations includes traffic situations for anticipating an out-of-sight traffic participant, the traffic situations comprising the out-of-sight traffic participant with active vehicle lighting, the active vehicle lighting being detectable in the field-of-view of the image sensor and illuminating one or more of objects, surfaces, or airborne particles in the field-of-view of the image sensor.

32. The method of claim 24, wherein the set of predetermined traffic situations includes traffic situations for anticipating traffic participants suddenly moving into a path of the host vehicle, the traffic situations respectively comprising the traffic participant with active vehicle lighting in the field-of-view of the image sensor, the active vehicle lighting being of a defined type.
